(19) United States
(12) Patent Application Publication
(10) Pub. No.: US 2016/0346931 A1
(43) Pub. Date: Dec. 1, 2016

(54) METHOD AND ARRANGEMENT FOR THE CORRECTION OF POSE ERRORS IN KINEMATICS AND A CORRESPONDING COMPUTER PROGRAM AND A CORRESPONDING COMPUTER-READABLE STORAGE MEDIUM

(71) Applicant: Johannes Gottlieb, Bellheim (DE)

(72) Inventor: Johannes Gottlieb, Bellheim (DE)

(21) Appl. No.: 15/228,855

(22) Filed: Aug. 4, 2016

Related U.S. Application Data
(63) Continuation of application No. PCT/EP2014/052150, filed on Feb. 4, 2014.

(30) Foreign Application Priority Data
Feb. 4, 2013 (DE) 102013101095.4

(51) Int. Cl. B25J 9/16

(52) U.S. Cl. CPC B25J 9/1692; G05B 2219/39017; G05B 2219/39018

(57) ABSTRACT

The invention relates to a method and a arrangement for calibrating a kinematics and a corresponding computer program and a corresponding computer-readable storage medium, which especially can be applied to extend the calibration to classes of parallel and serial robots, which have not been constructed especially for achieving the greatest possible accuracies, but which preferably have a high reproducability.

To this end, there is proposed a method which includes the following steps:
Moving the kinematics in that way that the kinematics takes a set of poses with a prescribed accuracy,
Determination of first configuration vectors by reading of the data describing actuator excursions in the particular poses,
Determination of a function for the transformation of the configuration space by evaluating of the first and the second configuration vectors, where the second configuration vectors are mapped each by a control function to one of the poses, and
Definition of a calibrated control function by successively executing of the function for the transformation of the configuration space and then of the control function.

### CROSS REFERENCE TO RELATED APPLICATION

This application is a continuation application of international patent application PCT/EP2014/052150, filed Feb. 4, 2014, designating the United States and claiming priority from German patent application no. 10 2013 101 095.4, filed Feb. 4, 2013, and the entire content of both applications is incorporated herein by reference.

### FIELD OF THE INVENTION

The invention relates to a method and an arrangement for calibrating kinematics as well as to a corresponding computer program and a corresponding computer-readable storage medium, which can be used in particular to expand a calibration to classes of parallel and serial robot kinematics, which have not been specifically designed to achieve utmost precision but can preferably have high reproducibility. The key terms are defined below.

### BACKGROUND OF THE INVENTION

A number of approaches for calibrating kinematics exist. Many calibration methods—also the method presented here—can be used with serial as well as parallel kinematics for robots and manipulators, as well as with measuring devices such as coordinate measuring machines or machine tools. The methods for pose error compensation of kinematics refer first to the kinematics itself, but frequently also include peripheral elements such as end effectors, various attachments and adapters. According to the prior art, the calibration is based mostly on obtaining a correct kinematics model of the individual to be calibrated by way of parameter identification, in-order to thereby compensate for the effect of differing geometry parameters.

The pose of kinematics as a function of an element of the configuration space is defined by a plurality of geometry parameters which is referred to as the “kinematics model” of this kinematics.

In particular, because of technical production-induced tolerance variations and limited tolerance dimensions in production, every individual of the same type shows deviations in its geometry parameters compared to the geometry parameters of its kinematics model specified by the design (such deviations will be termed in the following as intrinsic pose errors, in contrast to extrinsic pose errors, which are caused by exogenic influences on the kinematics).

Pose errors can also be caused by outside influences, such as force effects or temperature effects.

As a result, a control of kinematics only based on a nominal kinematics model causes pose errors. Because such pose errors cannot be neglected in many applications, calibration measures are required.

Since deviations in the geometry parameters are responsible for the majority of the pose errors, measures for the pose error compensation are in practice almost exclusively based on the most precise identification of the geometry parameters (“parameter identification”) for each individual.

This identification process is based on the comparison of a plurality of theoretically calculated poses of the kinematics with those poses that have been determined by precision measurements, starting from the same element of the configuration space. Extensive literature exists on this topic, which deals also generally with the topic of robotic pose error compensation. An example to be mentioned here would be:

Pandilov, Z. & Dukovski, V., Several Open Problems in Parallel Robotics, ACTA TECHNICA CONVINIENSIS, Bulletin of Engineering, Tome IV, 2011, pp. 77-84. ISSN 2067-3809

Briot, S. and Bonev, I. A., “Are parallel robots more accurate than serial robots?,” Transactions of the Canadian Society for Mechanical Engineering, Vol. 31, No. 4, pp. 445-456, 2007

Majarena, A. C.; Santolaria, J.; Samper, D.; Aguilar, J. J. An Overview of Kinematic and Calibration Models Using Internal/External Sensors or Constraints to Improve the Behavior of Spatial Parallel Mechanisms. Sensors 2010, 10, 10256-10297. oder

Lukas Beyer: Genauigkeitssteigerung von Industrierobotern, insbesondere mit Parallelkinematik. Dissertation, Helmut-Schmidt-Universitat Hamburg. Shaker Verlag, Aachen 2005, ISBN 3-8322-3681-3.

The pose error compensation based on parameter identification has a number of disadvantages. In fact, the parameter identification in the present class of problems has serious problems relating to the identification of the determined parameters (non-convexity of the error functions, i.e. ambiguity, numerical instabilities, etc.). The determined parameters replace the constructive geometry parameters of the elaborately constructed kinematics model installation of the components of the kinematics. Additional significant difficulties and uncertainties arise in the numerical determination of the geometry parameters from the measured data. The employed algorithms are heuristic (e.g. downhill-simplex), the reliability of the results is subject to considerable uncertainties, and the accuracy of the results must therefore be questioned in principle. Accordingly, very small deviations in the measured values can cause large deviations in the determined parameters. For example, random errors in the pose determination in individual measured poses affect the determined parameters in an unpredictable way. It is therefore not surprising that the state of the art is unsatisfactory and that intensive research is being conducted in the field of compensation of pose errors.

In the field of the invention, a calibration method is known from the German patent specification DE 10 2011 079 764 B3, wherein inverse kinematics is applied to measured poses in order to determine the actuator positions which lead to the measured pose.

### SUMMARY OF THE INVENTION

It was therefore an object of the invention to provide a method and an arrangement for calibrating kinematics as well as a corresponding computer program and a corresponding computer-readable storage medium, which obviates the aforedescribed disadvantages and more particularly allows determining reliable error measures for a variety of parallel and serial robot kinematics. An alternative to DE 10 2011 079 764 B3 is presented. In particular, the developing optical sensor technology has to be accounted for.

This object is solved according to the invention by the features recited in claims 1 and 9 to 11. Advantageous embodiments of the invention are recited in the dependent claims.

A special advantage of the invention is, that kinematics for all feasible poses can be corrected with high precision. This is accomplished according to the invention in the method for pose error correction by moving kinematics in a set of poses p(x). The poses p(x) ca be, for example, prescribed poses. According to a preferred embodiment, the poses p(x) are specified by a random algorithm. Pose p(x) is taken in a prescribed accuracy by the kinematics. After the kinematics has taken one of the (prescribed) poses p(x), a first configuration vector x*, associated with the pose p(x), is determined by reading the data describing the actuator excursion of the kinematics in pose p(x). In a preferred embodiment of the invention, the first configuration vectors x* associated with the poses p(x) are determined by reading the data for each pose which describe the actuator excursions of the kinematics in the respective pose taken. A configuration vector describes the actuator excursion or the actuator position of a kinematics. in a preferred embodiment, the approached actuator excursions are used as the actuator excursions associated with a pose p(x). Preferably, the actuator excursions of the kinematics itself are read. According to another preferred embodiment, kinematics is guided along a path, where first configuration vectors x* are determined at particular positions along the path. The respective poses can be measured before, after or concomitantly with the determination of the first configuration vectors x*. The method according to the invention further comprises the determination of a second configuration vector x related to pose p(x), where the second configuration vector x is characterized by being mapped onto the desired pose p(x) by a control function DK, i.e. DK(x)=p(x) or x=IK(p(x)). Generally speaking, the control function, also called direct kinematics, maps vectors x from a configuration space KR onto vectors p of a pose space PR:

DK: KR→PR; x [symbol] DK(x)=p.

For each kinematics the control function has to be defined the way that the kinematics will be moved to pose DX(x) when kinematics takes the actuator excursion or actuator position x. Due to error tolerances with the manufacturing of the kinematics or due to external effects and/or influences at the location of installation of the kinematics the pose, which maps the kinematics by applying the control function to a configuration vector x, deviates from the theoretically predicted or desired pose DK(x)=p(x). The pose actually taken with controlling, moving or commanding of the kinematics and using the configuration vector x is termed as the measured pose gDK(x) to the configuration vector x.

The external influences and/or effects can be, for example, external forces or temperature effects. In particular, in a preferred embodiment of the invention, effects of thermal expansions or deformations due to weight or inertia forces during operation of the kinematics are noticed and compensated for by an adequate transformation of the configuration space. Thus, according to the invention, the effect of exogenic impacts and moments in different poses is first either measured in the frame of a calibration process or determined by a simulative calculation. The effects of the impacts are then stored in a table as corrected differences of the actuator excursions for different locations of the configuration space, to be then evaluated in the frame of the transformation of the configuration space during operation of the kinematics.

Each control function DK is associated with an inverse mapping, the so-called inverse kinematics IK. By using the inverse kinematics IK, the particular actuator position x that results (theoretically) in the pose p when the control function is applied to the vector x is determined for each pose p. In a preferred embodiment the second configuration vector x is determined by IK(p(x))=x applying inverse kinematics IK to pose p(x) taken by the kinematics.

According to the invention, the first and the second configuration vectors x* and x associated with the respective pose are evaluated for at least a subset of the prescribed poses, in order to get a function for the transformation of the configuration space. Thereby, a corrective value Δx, e.g. Δx=x*−x, is determined for each prescribed pose p(x) in a preferred embodiment, and afterwards a global function for the transformation of the configuration space is determined. Preferably, the corrective value is a vectorial corrective value.

Knowing the second and/or first vector and the associated corrective values on the discrete subset of the configuration space, the set of corrective values is extended on further, preferably all elements of the entire configuration space, preferably by interpolation, extrapolation and/or approximation. By applying the corrective value, now an associated corrective vector from the configuration space can be attributed to each of the vectors of the configuration space. Mapping of the second vectors x to correct on corrected vectors x* can be regarded as transformation of the configuration space.

A calibrated control function is defined by using the function for transforming the configuration space, such that first the function for transforming the configuration space onto a vector x from the configuration space is applied, where after the control function is applied to the thus obtained transformed vector from the configuration space. Stated more precisely: When a pose p is to be taken, the vector x=IK(p) from the configuration space, which would theoretically result in the pose p, is determined via the inverse kinematics IK. The transformation is applied to this vector x to obtain a corrected vector. If pose p is one of the prescribed poses, the corrected vector is the read first configuration vector x* associated with the pose. The mapping of this transformation, i.e. the value obtained by performing this transformation, is also a vector which is typically an element of the configuration space. When this value is an element of the configuration space, this value is applied the direct kinematics DK. Otherwise, an unrealizable pose would be obtained. The calibrated control function is therefore the successive execution of the function for transforming the configuration space and of the (original) control function on the vector x. The calibrated control function instead of the (original) control function is now used for controlling, moving or commanding the kinematics.

In a preferred embodiment, the set of configuration vectors x′ is specified, and the kinematics is moved to these configuration vectors x′ by applying the control function. It is advantageous, if the specified configuration vectors x′ are the pre-image of the desired poses p from the control function. By this it can be achieved, i.e., that kinematics is moved close to the desired poses p. Preferably, the poses taken due to the commanding are measured. The result is termed as gDK(x′). Once the kinematics has been moved to a (erroneous) pose gDK(x′), the kinematics is moved to the exact pose p with a specified precision. In this preferred embodiment, the prescribed pose p is that pose on which the configuration vector x′ is mapped applying direct kinematics, i.e. p=DK(x′). The first configuration vector x* associated with pose p is determined for the prescribed pose p, as described above, by reading data which describe the actuator excursions of the kinematics in the taken pose p. Likewise, the respective second configuration vector x is determined as IK(p). This happens preferably by attributing the configuration vector x′ to pose p=DK. In this case, x=x′. From these first and second configuration vectors, the function for the transformation of the configuration space and the calibrated control function can be determined. With this method it is advantageous, if the prescribed configuration vectors x′ are attributed to the poses p, in which the kinematics has been moved, as second configuration vectors x.

Positioning of the kinematics by specifying the configuration vectors x′ before moving to the prescribed pose is especially advantageous, since therefore the configuration vectors x′ or x specified for the determination of corrective values can be equally distributed in the configuration space KR.

In a preferred embodiment, movement of the kinematics from the taken pose gDK(x′) into the prescribed pose p or close to the prescribed pose p which is determined by a specified error tolerance,
by minimizing the distance in the work space AR via forming differences in the work space AR, wherein in a preferred embodiment the poses taken by the kinematics are measured and the distance to the prescribed pose is minimized;
by minimizing the distance in an auxiliary space (control space) which can uniquely attributed to the configuration space KR or the work space AR,
by manually or in another way recurrently approaching the prescribed pose p or
by repeatedly approaching pose p and a subsequently performed error compensation calculation.

In a preferred embodiment of the invention the prescribed poses p are given by approached artefacts. In another preferred embodiment the approaching of the poses p takes place by means of measurement tools.

Advantageously, the method process for the correction of the pose errors is performed in a simulation, preferably with a computer-based simulation, and/or with a computer-generated model of the kinematics. This is especially of advantage for the correction of pose errors which are caused by external effects. An advantage of performing the method by means of a simulation and/or a model is that the amount of prescribed poses p(x) can be set very high, so that the accuracy of the global transformation function derived by interpolation, extrapolation and/or approximation increases.

According to a preferred embodiment of the invention, the actuator positions defined by the subset of first vectors x of the configuration space KR may largely be uniformly distributed in the configuration space. When an actuator operates, for example, in an interval [a, b] (which may be, for example, a translatory or rotatory interval), the interval is in accordance with this preferred embodiment uniformly divided into n equal sub-intervals. The boundaries of these sub-intervals are then used as predetermined components of first configuration vectors x′ of the configuration space KR. This generates a uniformly distributed grid of points in the configuration space KR. According to the invention, a respective correction value is assigned to each of these points, and the function for transforming the configuration space, which assigns to each point or vector x of the configuration space KR a correction value, is determined from this association for the discretely distributed points in the configuration space KR by interpolation, approximation or extrapolation. In a preferred embodiment, this function obtained by interpolation or extrapolation is continued to values of the configuration space that extend beyond the intervals realizable with the kinematics.

Since when measuring the poses taken by the kinematics even those poses can be determined, which cannot be theoretically reached by applying the control function to vectors from the range of values of the actuator intervals, a difference results between the work space, i.e. the set of the poses realizable with the kinematics when evaluating the control function, and the poses actually taken with the kinematics. According to a preferred embodiment, this difference is taken into account in the definition of the calibrated control function.

According to another preferred embodiment of the invention, a correction of a pose may be obtained with the method for pose error compensation of kinematics by using a corrective transformation of the configuration space. The corrective transformation of the configuration space is characterized in that, starting from a finite subset of the configuration space, a vectorial correction summand is determined for each element x of this set and the thereby defined function is expanded to the entire configuration space by an appropriate expansion of the definition range, and the corrective transformation for the entire configuration space is generated by adding the correction summands obtained by way of the expanded function, to the identical self-mapping of the configuration space onto itself. The corrected pose P of a kinematics individual is realized by first obtaining from the desired pose p by applying the inverse kinematics IK an element of the configuration space, by adding a correction value associated with this element to this element, and by thereafter commanding the pose.

According to a preferred embodiment, the sample set of a cuboid configuration space is used as predetermined configuration vectors (sample set) of the configuration space. A cuboid configuration space refers to the Cartesian product of all workspaces or actuator intervals [a(i), b(i)] (i=1, . . . , DOF). A cuboid element is to be understood as a multidimensional rectangular solid.

Advantageously, the actuator intervals [a (i), b (i)] (i=1, . . . , DOF) may be subdivided into further sub-intervals. Advantageously, the actuator intervals may be subdivided into sub-intervals of equal length. The interval boundaries W(j, i) with a(i)=W(0, i)<W(1, i)<W(2, i)<W(3, i) . . . <W(Q(i), i)=b(i) are also referred to as interval segmentation scalars. According to a preferred embodiment, the interval segmentation scalars of the actuator intervals do not include at least some of the endpoints of the actuator excursions, such that the cuboid included on the configuration space is a proper subset of the configuration space. The correction function is obtained through extrapolation in the difference set “configuration space \ cuboid.”

According to another preferred embodiment, the configuration space may be covered in its entirety or partially with finite elements. The corners of the finite elements are here measured as sample set. According to another preferred embodiment, n-simplexes are used as finite elements. The dimension n hereby corresponds to the degree of freedom DOF of the kinematics. Correction values for this sample set are determined, as described above, based on the sample set defined by the edges of the simplexes. These are then barycentrically interpolated in the interior of the individual simplexes or extrapolated outwardly. A transformation of the configuration space is defined, as described above, based on these correction values.

The aforementioned methods may be performed sequentially several times and/or combined with one another. Additional corrections based on error mapping and compensation calculations can be performed in some areas or points of the configuration space, of the work space, or of both spaces.

An arrangement according to the invention has at least one chip and/or processor, and is configured to execute a method for calibrating kinematics, wherein the method includes the following steps:
Moving of the kinematics in that way, that the kinematics takes a number of, preferably prescribed, poses with specifiable accuracy,
Determination of first configuration vectors by reading of the data describing the actuator excursions in the poses taken,
Determination of a function for the transformation of the configuration space by evaluating the first and second configuration vectors, where the second configuration vectors are mapped to a control function, each,
Definition of a calibrated control function by successively executing first the function for the transformation of a configuration space and afterwards the control function.

A computer program according to the invention enables a data processing device, after the computer program has been loaded into storage means of the data processing device, preferably in combination with a kinematics, to perform a method for calibrating kinematics, wherein the method includes the following steps:
Moving of the kinematics in that way, that the kinematics takes a number of, preferably prescribed, poses with specifiable accuracy,
Determination of first configuration vectors by reading of the data describing the actuator excursions in the poses taken,
Determination of a function for the transformation of the configuration space by evaluating the first and second configuration vectors, where the second configuration vectors are mapped to a control function, each,
Definition of a calibrated control function by successively executing first the function for the transformation of a configuration space and afterwards the control function.

According to a further preferred embodiment of the invention, the computer program according to the invention may have a modular structure, wherein the individual modules may be installed on various parts of the data processing device.

Advantageous embodiments additionally provide computer programs configured to perform additional process steps or process flows specified in the written description.

Another aspect of the invention relates to computer-readable data which include at least parts of the calibrated control function determined by the method of the invention and/or at least part of the correction values determined by the method according to the invention.

Such computer programs and/or computer-readable data may be provided, for example (for a fee or free of charge, freely accessible or password-protected) for downloading in a data or communication network. The provided computer programs can then be utilized by a method wherein a computer program and/or computer-readable data are downloaded from an electronic data network, for example from the Internet, to a data processing device connected to the data network.

The method according to the invention may be carried out by using a computer-readable storage medium on which a program is stored which enables a data processing system, after the program has been loaded into storage means of the data processing device, preferably in combination with a kinematics, to execute a method for calibrating kinematics, wherein the method includes the following steps:
Moving of the kinematics in that way, that the kinematics takes a number of, preferably prescribed, poses with specifiable accuracy,
Determination of first configuration vectors by reading of the data describing the actuator excursions in the poses taken,
Determination of a function for the transformation of the configuration space by evaluating the first and second configuration vectors, where the second configuration vectors are mapped to a control function, each,
Definition of a calibrated control function by successively executing first the function for the transformation of a configuration space and afterwards the control function.

Another aspect of the invention relates to a computer-readable storage medium on which data are stored, which include at least parts of the calibrated control function determined by the method of the invention and/or at least part of the correction values determined by the method according to the invention.

According to the preferred embodiment, the calibration is a succession of two successively performed compensations, where the first one was done iteratively in the work space to a prescribed finite sample set, that way, that a prescribed accuracy in approaching the desired pose is reached due to an iteration of successive pose movements. This method is especially applied when exactly placed artefacts are approached that define the prescribed poses. The second compensation is based on reading the actuator excursions related to the poses and the determination of a respective corrective mapping in the configuration space. So the second correction is done in the configuration space, first for the actuator excursions of the sample set, i.e. coordinates in the configuration space, and then after interpolation in a transformation of the configuration space. In particular, an exact compensation in the configuration space is only possible, after an exact compensation was performed in the work space. The exact compensation in the configuration space is performed on basis of the read actuator data, e.g. of the actuator excursions. At this point it should be emphasized that no parameter identification of the kinematics takes place with the calibration according to the invention, and thus this method is a parameter-free calibration method. This is especially of importance, because a calibration using parameter identification leads to so-called mathematically ill-posed problems and it ususally remains unsatisfying. Based on data obtained on a sample set, the non-parametric corrections provide in principle at each nonsingular point of the work space respectively associated locations in configuration space error corrected controls of the poses.

A particular advantage of the invention is that the performed localizations can be traed back with high accuracy to each official normal, e.g. the International Prototype Meter. Another advantage of the invention is that, due to the calibrated control function, the positioning accuracy of the calibrated kinematics can be improved globally, i.e. for the entire work space.

For the compensation in the work space, the prescribed poses are approached iteratively. In special cases, this can be done by approaching artefacts. In work spaces of higher dimensions and with a considerable amount of samples, this is usually not very practicable, however. As an alternative to approaching artefacts, highly exact external measuring tools, e.g. a coordinate measuring device, a multi-dimensional laser tracer etc., can be used to get iteratively to the desired poses.

The presented method of the transformation of the configuration space is not only applicable to active kinematics (robots), but can also be used to measure poses, e.g. coordinate measuring devices. Also their accuracy will be enhanced by applying the method of the transformation of the configuration space presented here.

According to the invention, the calibration presented here will be extended to kinematics of coordinate measuring machines, and to all other kinematics that are themselves used for pose measurements. This kinematics may have completely or partially non-driven actuators which, however, permit a determination of an excursion. The results of the poses measurements made by this kinematics are calculated by determining the actuator excursions. The calibration includes the following steps:
Moving of the kinematics in that way, that the kinematics takes a number of, preferably prescribed, poses with specifyable accuracy,
Determination of first configuration vectors by reading of the data describing the actuator excursions in the poses taken,
Determination of a function for the transformation of the configuration space by evaluating the first and second configuration vectors, where the second configuration vectors are mapped to a control function, each,
Definition of a calibrated control function by successively executing first the function for the transformation of a configuration space and afterwards the control function.

The following steps are now performed in the pose measurements with these thereby calibrated calibration machines:
Moving the kinematics to a pose that is to be determined
Reading the excursion sensors of all actuators and thus determining an element of the configuration space
Applying the transformation of the configuration space, as described above, to the measured vectors of the configuration space as a re-transformation of itself in order to obtain corrected configuration vectors
Applying direct kinematics to the configuration vector corrected by the re-transformation, and thus determining the pose by taking advantage of the calibration

The new method presented measures the positioning error in points that are obtained based on a “map” of the configuration space. Because the configuration space is formed especially simple and mostly has the shape of a cuboid, the uniform distribution of check points can be guaranteed easily in this space. A uniform distribution of check points in the configuration space also leads to a uniform distribution in the work space. This is because of constructive and functional presets in the construction of kinematics, where it has to be assumed that a small pose change is caused due to a small change in the configuration space, and on the other hand a small change in the configuration space only causes a small change in the work space.

One gets a set of poses in which the pose error is completely removed, except for small remaining errors, as a consequence of a compensation according to the method presented here. For the remaining points of the work space, reliable error estimates can be gained due to error estimates which are based on expected deviations of the geometry parameters. Thus, in contrast to the parameter identification, this new method has the property for the approval of pose errors by an accredited, state authority.

The application of kinematics which have a “certificate” regarding their precision, and additionally have an enhanced accuracy due to pose error compensation, and where the pose errors are clearly bounded, allow completely new application fields, especially in the field of robotics, e.g. in medical engineering, in micro- and nano-technology.

A further aspect of the invention concerns the correction of exogenic pose errors. The exogenic pose errors can be, for example, pose errors that are caused by external forces and/or by thermoelastic deformation of the kinematics.

In order to determine a corrective mapping, a corrective matrix is attributed to each element of the pose set selected for data acquisition. This matrix is valid in relation to a single pose.

1. Determination of a Local Corrective Matrix for a System of Forces

(a) Reduction of a Set of Force Sizes (“Force Size System”)

The term (“force size”) is derived from statics and is the hypernym for “force” and “moment”. Force size system here refers to a set of force sizes.

When a force size system is given and an arbitrary point in the space is set as the kanonian reference point, then applies: Each given force size system can be described using two three-dimensional vectors, on force vector and one moment vector, where the force vector affects the kanonian reference point (impact point).

The reduced description of a force size system requires a six-dimensional vector.

When reducing the set of forces, it is taken advantage of the fact that each force vector can be arbitrarily shifted in parallel, if the resulting offset moment is considered (“displacement moment”).

Reducing the forces, these are individually shifted in parallel into the reference point, where the resulting shifting moments are added to the force size system. All force vectors running through the kanonian reference point can then be added up.

The (“free”) moment originally comprised in the set of force sizes are eventually added up with the free shifting vectors to a single vector.

When reducing the force size system, the choice of the kanonian reference point is not important. This means in particular, that the reference point—irrespective of the taken pose—can be put into a fixed point of the world-coordinate system. This fact later leads to a reduction of the calculation effort during the evaluation of the corrective matrices for the pose correction, since an acting force size system needs not be reduced pose-dependently to various kanonian reference points.

It should not be confusing when, following the choice of the kanonian reference point, the line of action of the resulting force vector does not penetrate the mobile platform, which it affects.

(b) Determination of the Pose Change as a Result of the Force Size System

Force sizes cause elastic deformations of the kinematics, which finds expression in a change of pose.

Such a pose change can be determined using finite-element-software, e.g. ANSYS™.

More simply, the change of the actuator excursion can be determined by an impact with a force size system by balancing forces and moments of the force size system with the forces and moments which are caused by the actuators themselves.

Because the total sum is known (the resulting force vector and the resulting moment vector are zero vectors), the forces and moments acting on the actuators can be determined.

In a preferred embodiment, a Hook spring constant is attributed to each actuator, which one gets by modeling or measurement. Hereby also changes in the actuator excursions are caused.

In this simplified approach, a rigidity of all other components is assumed.

c) Determination of the Local LKinear Corrective Mapping

Every force size system can be represented by six components, because the force vector and the moment vector have three components, each.

Let p be a given pose, and x be the respective vector of the configuration space x=IK(p).

When pose p acts upon one of the aforementioned six components of a force size system, then a vectorial correction dx in the configuration space can be determined for each of its components. dx therefore represents the changes in the actuator excursions.

A respective linear behavior can indeed be assumed for these small elastic deformations.

As mentioned before, the corrective vectors dx can be derived from a real kinematics by data acquisition, e.g. measuring of the poses taken and/or reading of data which describe the actuator excursions. Alternatively, or additionally, the corrective vectors dx can also be derived from evaluation of preferably computer-based simulations and/or model calculations.

In a preferred embodiment, a model of a kinematics is moved into the prescribed poses in a computer simulation, and the first configuration vectors of the kinematics model related to the taken, prescribed poses can be read from the simulation. The model describes the geometric, kinematic and/or dynamic properties of the kinematics. Preferably, the model of the kinematics is impinged simulatively with defined external impacts. For example, those impacts of force sizes or temperatures can be simulated for displacement paths of kinematics. Those external impacts for instance can be simulated by finite-element software.

After that, the first and second configuration vectors are evaluated, as described above, in order to obtain the function for the transformation of the configuration space and the corrected control function. The second configuration vectors are defined by being mapped to one of the prescribed poses p(x), each, by the control function, i.e. x=IK(p(x)).

In an alternative method, a model of a kinematics is moved in a computer simulation according to a prescribed number of first configuration vectors of the configuration space, where a control function is applied to the configuration vectors and where the model of the kinematics is impinged simultatively with defined external impacts. After that, the poses of the kinematics model taken after the movements in the simulation are determined. The inverse function for the control function is applied to these poses, in order to gain second configuration vectors. For at least a subset of the first configuration vectors a corrective value is determined by evaluating the subset of the first and respective second configuration vectors. By evaluating the corrective values, a function for the transformation of the configuration space in obtained, and corrected control function is defined as a successive executing of first the function for the transformation of the configuration space and then the control function. This corrected control function compensates for the external impacts.

For the correction of intrinsic errors this method has already been described in patent specification DE 10 2011 079 764 B3. In a preferred embodiment, this method for pose error correction is used for the correction of pose errors caused by external impacts, where the method is used for the evaluation of data, especially of at least first and second configuration vectors and/or of poses that are created by a computer simulation of the kinematics and of the computer-simulated behavior of the kinematics.

Such a method for the correction of pose errors of a kinematics comprises the following steps:
Providing a computer-controlled model of the kinematics,
Moving the model of the kinematics according to a prescribed amount of first configuration vectors of a configuration space, where a control function is applied to configuration vectors, and where an impact within the model with external effects is simulated,
Determination of the poses taken by the model of the kinematics as a result of the movement,
Application of an inverse function of the control function to the poses for the determination of second configuration vectors,
Determination of a corrective value for at least a subset of the first configuration vectors by evaluation of that subset of the first and related second configuration vectors,
Determination of a function for the transformation of the configuration space by evaluating the corrective values, and
Definition of a corrected control function by successively executing of first the function for the transformation of a configuration space and then of the control function.

So we get a corrective matrix M of a dimension of 6×6 (or more generally of the dimension 6× DOF) related to the configuration space. Its columns represent the changes of the 6 (or more generally DOF) actuator excursions, each of which results from one component of the resulting force size system.

Thus we get

dx=M*S,

with
dx: vector of the change in actuator excursion
M: corrective matrix
S: vector of the force size system, consisting of force vector and moment vector.

Since, in contrast to the calibration of a kinematics—for example with the calibration according to the invention described above—the corrective matrices can be obtained by calculations, and therefore no measurements are required, the sample number of the poses and thus the number of corrective matrices can be chosen much higher than with a calibration or pose error calibration which is performed using a real kinematics.

Impairment of the effort when performing the evaluation for the pose correction due to the large number of the corrective matrices is marginal.

d) Determination of the Global Corrective Mapping

Analogous to the correction of pose errors described above, a corrective matrix is determined for each element x′ of the sample set—ensuing from prescribed poses and/or a pose set of the configuration space. Hereby the effect of each component of the force size system on the Tool Center Point (TCP) is considered. If the platform can be regarded as rigid, then an arbitrary point can be used as an impact point of the force size system.

The corrective matrices can now be interpolated, extrapolated or approximated to the entire configuration space. Thus, a corrective matrix is defined for any vector x of the configuration space, which, together with the six components of the resulting vector of the force size system, defines a shift dx in the configuration space. With that, a compensation of the acting force size system is given.

There are two options for the attribution of the corrective matrix M:

i) A corrective matrix M derived from pose gDK(x), which was moved to by applying the control function to x (where usually gDK(x)≠DK(x)), is attributed to a configuration vector x. This is the case, for example, if the corrective matrix is derived based on a model of the ideal kinematics.

ii) A corrective matrix M derived from pose DK(x) is attributed to a configuration vector x. This is the case, for example, if the corrective matrix is derived based on a model, in which the corrected control function (without regarding exogenic impacts) is already being applied.

A control function which considers both error impacts, i.e. constructive tolerances and exogenic influences and/or effects, can be obtained by successively executing the corrected control function and the compensation of the acting force size system.

In special cases, e.g. when the transformation function for the calibration and the corrective function are an addition of vectors, the order of the executions of calibrated control functions and compensation of the acting force size system is not important.

2. Determination of the Local Corrective Matrix for the Compensation of Thermoelastic Deformation

When reducing the impact of thermoelastic deformation to the linear extension of the joint rods of a hexapod, i.e. the “change in leg length”, the temperature compensation can easily be obtained by means of corrective vectors in the configuration space.

Therefore, the application of a finite-element-software for general kinematics is assumed in the following.

Firstly, the corrections in the configuration space are determined for each element of the pose sample set in form of a DOF×DOF corrective matrix T (diagonal matrix). The vector of the corrective leg-length-change in the poses is derived by multiplication of this matrix by the observed temperature-based difference (temperature drift).

The corrective matrices of the sample set are then extended to the entire configuration space by interpolation, extrapolation or approximation.

At a given pose and a given temperature drift, first the corrective matrix related to the pose is calculated and multiplied by the temperature drift, in order to obtain corrected leg-length changes.

The determination of the global correction mapping takes place analogously to that of the correction of the force size system.

In general, correction variables (and global correction mappings) for different external impacts can be determined analogously.

There is also the possibility of compensating the temperature drift by means of measurements, beside the aforedescribed numerical temperature drift compensation. The intrinsic correction and the correction of exogenic temperature effects can be performed in combination by performing the intrinsic correction e.g. at three different temperature values in the relevant temperature range (spatially constant temperature distribution is assumed for the kinematics).the respective transformations of the configuration space are then amended by interpolation, approximation or extrapolation in the temperature range.

A different case of pose errors which can be compensated for concerns a time-dependent heating and/or heating in which parts of the kinematics are subject to different temperatures, as e.g. observed with heating of a kinematics from the tool.

### The Present Invention Uses

(I) empirically obtained data poses compensation, which have resulted for selected poses in certain processes of motion from deformation by exogenous impacts, and/or

(II) data for the poses compensations, which were determined by computationally intensive simulation calculation under certain circumstances.

The correction data of both versions have a matrix structure for moment components and power components. This is represents a generalization of the transformation of the configuration space (each grid point of the configuration space is associated with a correction matrix.). Here, the generalized transformation of the configuration space is the decisive step towards the practical applicability of such compensations.

In the following the invention will be explained in detail with reference to examples of calibrating kinematics. It should be noted that the invention is not limited to the embodiments described below, but that the invention also includes other methods, devices, computer programs, or storage media, as long as these only implement all the features of the independent claims.

### BRIEF DESCRIPTION OF THE DRAWINGS

The exemplary embodiments will be described in more detail with reference to the appended drawings, which show in:

FIG. 1 Visualization of a first example of a pose error correction,

FIG. 2 Visualization of a second example of a pose error correction, where the pose error is caused by exogenic impacts,

FIG. 3 Visualization of a third example of a pose error correction, where the pose error is caused by exogenic impacts,

FIG. 4 Visualization comparing the second and third application examples.

### DESCRIPTION OF THE PREFERRED EMBODIMENTS OF THE INVENTION

By reference to FIG. 1 and FIG. 4, the correction will be described more in detail using an example of a kinematics 100.

In reference to the following example, shown in FIG. 1, it will be described how the correction for the desired pose p is performed. This correction is performed for a prescribeable sample number of poses and subsequently extended to the entire configuration space KR.

In an exemplary embodiment a configuration vector x is determined for the desired pose p(x) by applying the inverse kinematics to p(x), i.e. x=IK(p(x)). The kinematics is moved in one step 100 according to the determined configuration vector x, i.e. by applying the control function to the configuration vector x. Usually, this movement leads, because of intrinsic errors, to pose gDK(x), which deviates from the desired pose p(x). Preferably, the pose taken is measured and marked as the pose gDK(x) measured to x.

After that, the kinematics is moved to the desired pose p(x) in step 102. That can be done by manual or a different kind of fed back approaching to the prescribed pose p(x) or by applying distance minimization. When the kinematics has reached the desired pose p(x), then the actuator excursions x*, which corresponds to the first configuration vector, are read in a step 104.

A corrective value dx, which is a corrective vector in an exemplary embodiment, is determined from the configuration vector x and the configuration vector x*.

Such a corrective value is determined for each pose of the sample set, and then a corrective function is determined for the entire configuration space KR by interpolation, extrapolation and/or approximation. In an exemplary embodiment the corrective function maps a configuration vector x=IK(x) to a corrective vector x*. For the poses of the sample set the configuration vector x* corresponds to the actuator excursions of the kinematics, when the kinematics takes pose p(x).

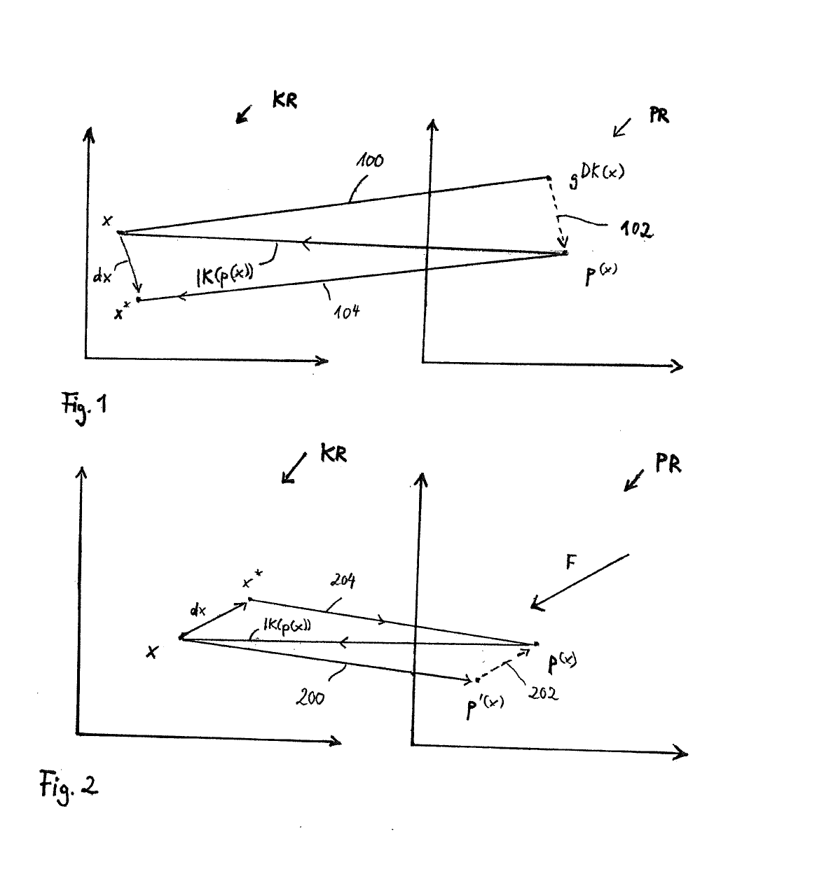

In FIG. 2 an exemplary embodiment is visualized for the correction of pose errors which are resulting from, for example, an external force size acting on the kinematics, e.g. caused by a tool installed in the TCP.

As mentioned before, the determination of the corrective matrices M can be performed on a real kinematics, where the kinematics is impinged by defined, real force sizes. The corrective matrices can be determined for the poses of a pose set, for example according to the method shown in FIG. 1, by moving the kinematics impinged by the force sizes to the desired poses p(xi) (I=1,2, . . . , n) and reading the respective configuration vectors xi*.

The determination of the corrective matrices M can also be performed by means of a simulation of a kinematic model, where the kinematic model is impinged by simulated forces sizes. An exemplary embodiment will be described in the following, where an ideal control function is applied to the kinematic model. By an ideal control function we understand a control function that has not yet been corrected for intrinsic errors.

A configuration vector x can be determined to a desired pose p(x) by applying the inverse kinematics to p(x), i.e. x=IK(p(x)), and the kinematic model impinged by the simulated force size is moved according to the configuration vector x in step 200. Effected by the force size F, the kinematics model takes pose p′(x). In a subsequent step 202 the kinematic model is moved to pose p(x), and in step 204 the respective configuration vector x* is read. Analogous to the correction for the intrinsic errors, now the corrective values dx and the global corrective function are determined for the defined force sizes.

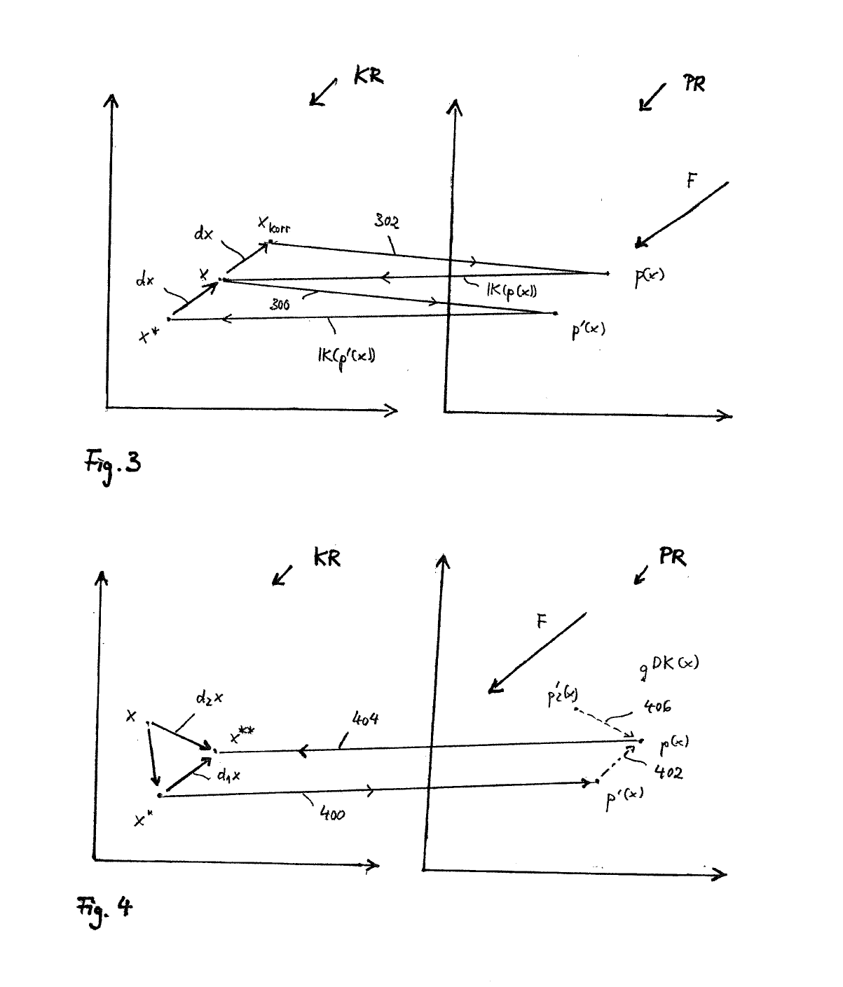

An alternative method for the correction for exogenic pose errors is described in reference to FIG. 3. According to this method, again the respective configuration vectors for the poses p(x) of a sample set are determined as x=IK(p(x)) by evaluating the inverse control function IK. In step 300 the kinematic model impinged by the simulated force size is moved. As a result of the impact of force size F, the kinematic model takes pose p′(x). The inverse control function is applied to this pose p′(x), in order to obtain a respective configuration vector x*. By an evaluation, as known from for example from patent specification DE 10 2011 079 764 B3, a corrective value dx is determined. A corrective function for the entire configuration space KR is determined from the corrective values dxi (i=1,2, . . . , n) of the sample set by interpolation, extrapolation and/or approximation. In an exemplary embodiment, dx is determined as dx=x−x*, and the corrective function maps the configuration vector x=IK(p(x)) to the configuration vector xkorr=x+dx. The non-corrected ideal control function is applied to the corrected configuration vector xkorr in step 302. The corrected control function, which compensates for the exogenic effects of force size F, is defined in this example as a successive execution of the corrective function and then of the ideal control function.

To compensate for intrinsic and exogenic errors, the respective corrective functions are executed successively, and the ideal control function is applied to the representation of the configuration vector x.

Since the kinematics model is an idealized model of the kinematics, i.e. since there are no intrinsic errors in the simulation, the ideal control function is used in the simulation.

When the corrective function is determined based on a real kinematics, then either the ideal control function or the control function corrected for the intrinsic errors can be used in steps 200, 300 or 302.

The differences between these two methods are visualized in FIG. 4. If pose p(x) is to be approached by effect of the (real) force size F and if for the movement of the (real) kinematics in step 400 a corrected control function is used, which has already been corrected for the intrinsic errors, then the kinematics is moved to pose p1′(x), whereby in a first step the configuration vector x=IK(p(x)) is mapped to the configuration vector x* by a first corrective function, which compensates for the intrinsic errors, and where then the not-corrected control function is applied to the configuration vector x*. For the determination of the correction of the exogenic force effect, the kinematics is moved to pose p(x) in step 402, and in step 404 the configuration vector x** is determined reading the actuator excursions. By evaluating the configuration vectors x* and x**, a corrective value d1x is determined. A second corrective function, which corrects the exogenic effects, is determined for the sample set from the corrective values d1xi (i=1,2, . . . , n), as described in the first example. A corrected control function, which compensates both for the intrinsic and exogenic errors, is obtained by successively executing of the first and the second corrective function, which maps the configuration vector x to the configuration vector x**, and of the subsequent application of the non-corrected control function to the configuration vector x**.

If the non-corrected control function is used for the movement of the kinematics when determining the corrective function for compensating for exogenic effects, then the kinematics is moved by effect of force size F to pose p2′(x), from where the kinematics is moved to the desired pose p(x) in step 406, and finally the corrective value d2x is obtained. As described above, a third corrective function is determined for the sample set from the corrective values d2xi (i=1,2, . . . , n), which corrects both the intrinsic and the exogenic impacts.

The same third corrective function can also be obtained, when admittedly for the movement of the kinematics the corrected control function is used, which has already been settled, but the corrective value is obtained by evaluation of the configuration vectors x and x**, which is then d2x.

A corrected control function, which compensates both for the intrinsic and the exogenic errors, can be obtained by successively executing the third corrective function, which maps the configuration vector x to the configuration vector x**, and the application of the non-corrected control function to the configuration vector x**.

Which one of the corrective functions—the first one combined with the second one, or the third one—is to be used, will be decided by the expert considering the conditions.

The invention is not limited in its embodiment to the above-described preferred exemplary embodiment. Instead, a number of variations are possible, which makes use of the method according to the invention, the apparatus according to the invention, the computer program according to the invention and the computer-readable storage medium according to the invention even in fundamentally different embodiments.

### Definitions and Explanations

The exemplary embodiments will now be supplemented by some notes relating to the basic concepts of calibration:

Kinematics

The term kinematics refers to both the class of serial and parallel kinematics, and also combinations of the two classes. The classes include, for example, robots, machine tools, processing machines, manipulators, coordinate measuring machines, solid body robots. Furthermore, the classes also include kinematics provided with redundant sensors.

Actuator

In the present document, an actuator is defined as follows: An actuator is a technical device that converts an input value (electrical voltage, digital value, etc.) to a physically realized parameter or to a change in a physical parameter that represents a degree of freedom of the kinematics. The excursion of the actuators can be determined, for example, from a known relationship between excursion and input value or realized, for example, with special measuring devices. Actuators are those technical components whose excursions represent the elements of the configuration space. In addition to mechanically acting actuators, actuators also include elements of the kinematics that only perform measurements. In particular, the actuators include linear actuators, rotary tables and linear measuring devices and rotary measuring devices, actuators from memory alloys, piezoelectric ceramics, pneumatic or hydraulic implementations, etc.

Freedoms of the Kinematics (DOF, Degree of Freedom)

DOF is defined as the number of degrees of freedom of the kinematics. In the presented method, the number of the actuators in the kinematics suitable for the method is DOF. If redundancy exists, i.e. if the number of actuators exceeds the DOF, then DOF actuators are selected and taken into account in the calibration according to the invention.

Pose (P)

The pose of kinematics refers to the combination of position and orientation or components or subsets thereof of all moving rigid bodies relevant for the kinematics.

Usually, the pose is associated with a single rigid body. According to the invention, however, kinematics composed of several sub-kinematics can be calibrated with corresponding relevant rigid bodies.

Pose Space (PR)

The pose space area is to be understood as either the set of all poses theoretically attainable with kinematics, or even a suitable superset of these poses, such as the special Euclidean group SE(3) for the Gough manipulator.

Configuration Space (KR)

Kinematics is controlled by actuators. The respective excursions of the actuators 1, 2, 3, . . . , DOF can be expressed as a vector x. Within the context of this patent, the configuration space is thus that part of the RDOF provided during the operation of the kinematics.

Direct Kinematics (DK)

A direct kinematics is a function that assigns the corresponding pose from the pose space to an element from the configuration space.

DK: KR→PR

This assignment is done in a theoretical manner and is based on the constructive geometry parameters of the kinematics. In practice, the reversible unambiguity is ensured, and without loss of generality a reversible unambiguous mapping is assumed here.

Usually, the Direct Kinematics is stored as a function in a control computer.

Work Space (AR)

The work space is the part of the pose space provided for the operation of the kinematics. It is the set of all poses that a robot is capable of taken and should take in normal operation.

Inverse Kinematics (IK)

An inverse kinematics is a function that assigns to each pose from the pose space the corresponding element from the configuration space. IK is the inverse mapping of DK.

IK: PR→KR

Usually, the inverse kinematics is stored as a function in a controller.

Measured Direct Kinematics (GDK)

The actually taken pose in this configuration can be determined for each element from KR by a measurement—for example by using a coordinate measuring machine. The mapping of the elements of KR onto the actually taken pose is referred to as measured direct kinematics (GDK).

GDK maps the configuration space onto the work space:

GDK: KR→AR

Sample Set of the Configuration Space (PM)

A set of elements from the configuration space that is provided for the calibration is selected as PM.

Corrected Direct Kinematics PM (KDK_PM)

A p ε AR is assigned to each element x ε PM according to:

KDK_PM(x)=DK(x+KSF_PM(x)).

### Glossary

### Gough Manipulator

Refers to a parallel manipulator with DOF=6 wherein a movable and a static part are interconnected by 6 variable-length legs. Gough manipulators are also known as hexapods.

Nₖ Nₖ={1, 2,3 . . . k}, k ε N
DOF Degree of Freedom, degree of freedom of kinematics
i i ε N_{DOF}, i always labels the actuators
[a(i) b(i)] interval of the allowable excursions of the actuator i
Q(i) Q(i) is the number of interval divisions for the actuator i
Orientation indicates how a body is oriented in three-dimensional space. The set of orientations in three-dimensional space is referred to as special orthogonal group SO(3).
x an element of the configuration space, represented as a vector of the actuator excursions
p element of the pose space, represented by a vector

What is claimed is:

1. A method for calibrating kinematics, the method comprising the steps of:
moving the kinematics in that way that the kinematics takes a set of poses with a prescribed accuracy,
determination of first configuration vectors by reading of the data describing actuator excursions in the particular poses,
determination of a function for the transformation of the configuration space by evaluating of the first and the second configuration vectors, where the second configuration vectors are mapped each by a control function to one of the poses, and
definition of a calibrated control function by successively executing of the function for the transformation of the configuration space and then of the control function.

2. The method according to claim 1, characterized in that for the determination of the configuration vectors
the data describing the actuator excursions in the taken poses are read and/or
the approached actuator excursion are used.

3. The method according to claim 1, characterized by the pre-image of the pose being determined by the control function and the kinematics being moved according to the pre-image by applying the control function and finally being moved to the poses.

4. The method according to claim 1, characterized in that the poses are given by artefacts and/or the kinematics is moved to the poses by means of measurement tools.

5. The method according to claim 1, characterized in that the function for transforming the configuration space is determined for further configuration vectors, different from the first and/or the second configuration vectors, by interpolation, extrapolation, approximation or a combination of these.

6. The method according to claim 1, characterized in that the differences between the work space, i.e. the set of poses feasible for the kinematics by evaluation of the control function, and the poses actually taken by the kinematics are determined and considered when defining the calibrated control function.

7. The method according to claim 1, characterized in that the method steps are performed with a real kinematics or with a computer-controlled model of the kinematics.

8. The method according to claim 1, characterized in that the kinematics is impinged by exogenic impacts and/or the kinematic model is impinged by simulated exogenic impacts.

9. Method for the correction of pose errors of a kinematics, where the method has following steps:
providing a computer-controlled model of the kinematics,
moving the model of the kinematics according to a prescribed amount of first configuration vectors of a configuration space, where a control function is applied to configuration vectors, and where an impact within the model with external effects is simulated,
determination of the poses taken by the model of the kinematics as a result of the movement,
application of the inverse function of the control function to the poses for the determination of second configuration vectors,
determination of a corrective value for at least a subset of the first configuration vectors by evaluation of that subset of the first and related second configuration vectors,
determination of a function for the transformation of the configuration space by evaluating the corrective values, and
definition of a corrected control function by successively executing of first the function for the transformation of the configuration space and then of the control function.

10. An arrangement with at least one chip and/or processor, where the arrangement has to be installed in that way, that a method for the calibration of the kinematics according to claim 1 is feasible.

11. A computer-readable storage medium with a stored program that enables a data processing device, after the program has been loaded into storage means of the data processing device, to execute a method according to claim 1, and/or on which computer-readable data are stored comprising at least parts of the calibrated control function defined by the method according to claim 1 and/or at least parts of the correction values determined with the method according to claim 1.
